(19) United States
(12) Patent Application Publication
(10) Pub. No.: US 2014/0173160 A1
(43) Pub. Date: Jun. 19, 2014

(54) Innovative Structure for the Register Group

(71) Applicants: Wenjia Li, Beijing (CN); Tonghai Gao, Beijing (CN); Qiang Wang, Beijing (CN); Gan Wen, Beijing (CN)

(72) Inventors: Wenjia Li, Beijing (CN); Tonghai Gao, Beijing (CN); Qiang Wang, Beijing (CN); Gan Wen, Beijing (CN)

(73) Assignee: TELEFONAKTIEBOLAGET L M ERICSSON (PUBL), Stockholm (SE)

(21) Appl. No.: 14/123,810

(22) PCT Filed: Jun. 7, 2011
(86) PCT No.: PCT/CN2011/000948

§ 371 Date: Feb. 4, 2014

(51) Int. Cl. G06F 13/40

(52) U.S. Cl. CPC G06F 13/4063
USPC 710/305

(57) ABSTRACT

A processing circuit comprises a plurality of modules connected in series to form a module pipeline. Each module comprises one or more registers having corresponding addresses within an address range for the module. A register request, including a target register address, is passed from one module to succeeding modules down the module pipeline until the register request is received at the module containing the targeted register. Data is written into or read out from the targeted register.

### TECHNICAL FIELD

The present invention relates generally to processing circuit architecture and, more particularly, to a pipeline architecture for a processing circuit having multiple modules connected in series to form a module pipeline.

### BACKGROUND

A processing circuit for a mobile terminal or other device may be implemented as an Application Specific Integrated Circuit (ASIC), or Field Programmable Gate Array (FPGA) where different functions are implemented by different modules. Implementation of different functions in different modules enables one module to be updated or replaced without affecting the function of the other modules. Configuration data, status information, and other data used by a module to implement its assigned functions are stored in registers. The use of registers for storing configuration data enables the modules to operate in multiple modes and to perform multiple functions.

The organization of the registers in the processing circuit is one design consideration. One conventional approach to organizing the registers is to centralize all registers in a register unit. Each module interfaces directly to the matched registers. The register unit is responsible for decoding registers addresses and outputting stored values to corresponding modules.

This centralized approach has several disadvantages. For example, the centralized solution requires the register unit to decode all register addresses, which generally requires complex logic, and thus, leads to timing problems. Further, because the register unit is responsible for distributing all registers to the modules, it needs to interface with all of the modules. This one-to-many interface may lead to a routing jam at the register module group. In addition, this solution is hard to update. For example, if a new module is added or removed, the register unit and the corresponding logic have to be revised.

Another conventional approach to organizing the registers is to distribute the registers among modules connected to an internal register bus. In this approach, each module includes its own register group and decoder and is connected to an internal register bus. A bus converter provides an external interface to the register bus and converts the external interface protocol into the internal register bus protocol. All of the modules monitor the internal register bus simultaneously. When a register request is asserted, all of the modules decode a target register address associated with the register request. If the target register address specifies a register that belongs to the module, the module latches the register data into or reads register data from the specified register. All other modules do nothing.

While the internal bus structure eliminates the one-to-many interface and the update problems associated with the centralized register solution, the bus structure solution still encounters timing problems. In particular, as the number of modules interfacing with the internal register bus increases, the fan-out of the register bus is very high, which results in a large timing delay.

Thus, there remains a need for an improved processing circuit architecture that eliminates or reduces timing problems associated with the conventional approaches.

### SUMMARY

A processing circuit comprises a plurality of modules serially connected by a plurality of register bus segments to create a module pipeline. Each module comprises one or more registers and is assigned a corresponding address range. A register request, including a target register address, is passed from one module to the succeeding module down the module pipeline until the register request is received at the module containing the targeted register.

Exemplary embodiments of the invention comprise methods implemented by a processing module connected with a plurality of like modules in a module pipeline. In one exemplary method, a register request including a target register address is received over a first interface connected to a preceding module by a first segment of an internal register bus. The target register address is compared to an address range of the processing module. If the target register address falls within the address range of the processing module, a matching register in the processing module is accessed to write data to or read data from the matching register. If the target register address falls outside the processing module's register address range, the register request is output over a second interface to a succeeding module connected to the processing module by a second segment of the internal register bus.

Other embodiments of the invention comprise a processing module in a processing circuit connected to a plurality of like modules forming a module pipeline. One exemplary processing module comprises a first interface, a second interface, one or more registers for storing data, and a decoder. The first interface connects to a preceding module via a first segment of an internal register bus. The second interface connects to a succeeding module via a second segment of the internal register bus. The decoder is configured to receive a register request over the first interface and to compare a target register address associated with the register request to an address range for the processing module. If the target register address falls within the register address range, the decoder accesses a matching register in the processing module to write data into or read data from the matching register. If the target register address falls outside the address range of the processing module, the decoder outputs the register request to the succeeding module over the second interface.

Other embodiments of the invention comprise a method implemented by a processing circuit having a plurality of modules connected to form a module pipeline. In one exemplary method, a register request including a target register address is sequentially passed through the plurality of modules serially connected by an internal register bus. The internal register bus comprises a plurality of segments connecting adjacent modules. At each module receiving the register request, the target register address is compared to an address range of the receiving module. If the target register address falls within the address range of the receiving module, a matching register within the receiving module is accessed to write data into or read data from the matching register. If the target register address falls outside the address range of the receiving module and if there is a succeeding module, the register request is passed to the succeeding module over the internal register bus.

Other embodiments of the invention comprise a processing circuit with a pipeline architecture. In one embodiment, the processing circuit comprises a plurality of modules, an internal register bus having two or more segments connecting the plurality of modules in series to form a module pipeline, and a decoder for each module. Each module includes one or more registers. The internal register bus is configured to pass a register request including a target register address through the serially connected modules. The decoder for a receiving module is configured to compare the target register address to a register address range for the receiving module. If the target register address falls within the register address range of the receiving module, a matching register within the receiving module writes data into or read data from the matching register. If the target register address falls outside the register address range of the receiving module and if there is a succeeding module, the decoder passes the register request to the succeeding module.

The pipeline architecture and techniques herein described provide improved timing performance as compared to the conventional solutions. Further, the processing circuit is more easily extended by modifying existing modules or adding new modules to the pipeline. Because the registers are implemented inside respective modules, modifications to one module will not affect other modules.

### BRIEF DESCRIPTION OF THE DRAWINGS

FIG. 1 shows a block diagram of a processing circuit having serially connected modules according to one exemplary embodiment.

FIG. 2 shows a block diagram of an exemplary module for the configurable circuit of FIG. 1.

FIG. 3 shows an exemplary method performed by a module.

FIG. 4 shows an exemplary interface diagram between three modules.

FIG. 5 shows another exemplary method performed by a module.

### DETAILED DESCRIPTION

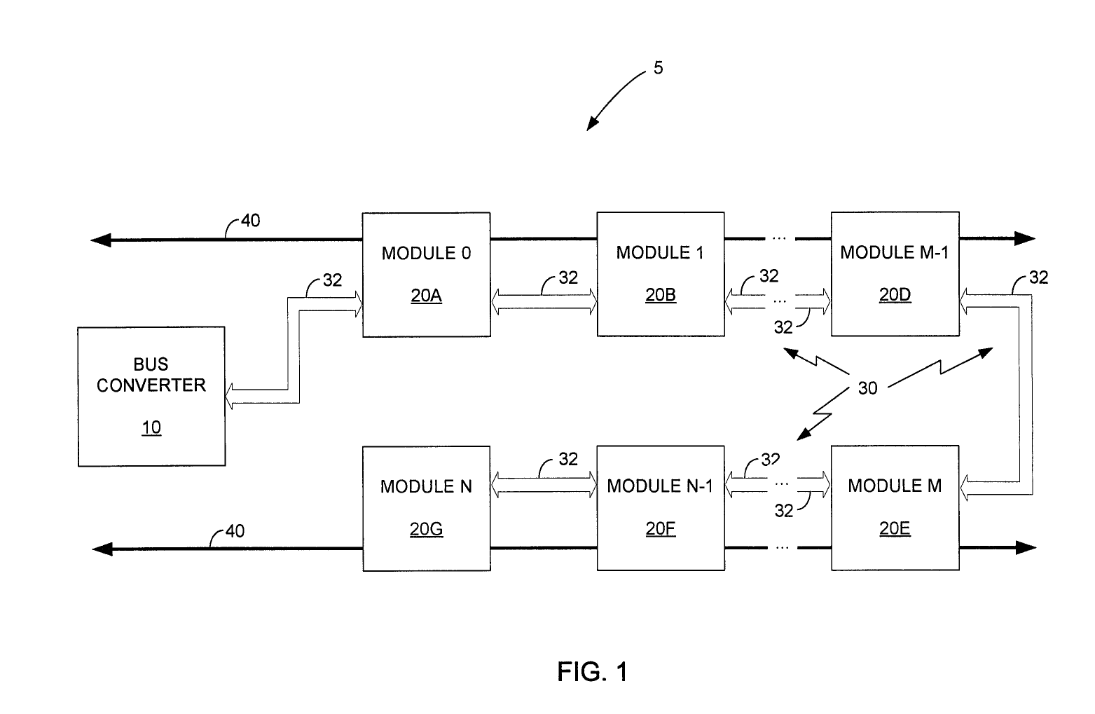

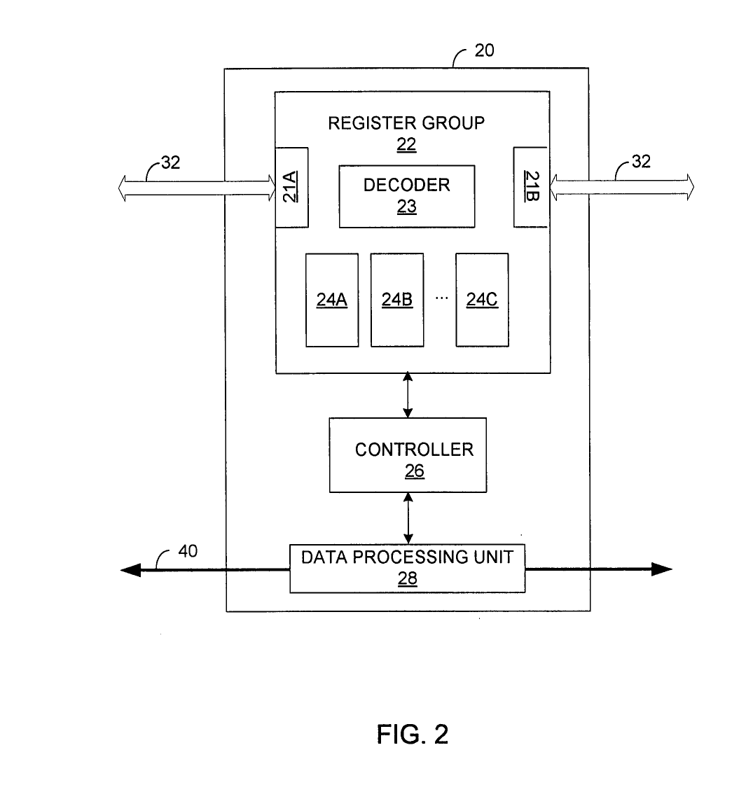

FIG. 1 shows a processing circuit 5 according to one exemplary embodiment. The processing circuit 5 may comprise, for example, an Application Specific Integrated Circuit (ASIC) or Field Programmable Gate Array (FPGA). Processing circuit 5 includes a bus converter 10 and a plurality of modules 20A-G. As will be described in more detail below, each module 20 includes one or more registers 24 (FIG. 2) for storing configuration data, status information, or other data used by the module 20. The bus converter 10 and modules 20 are connected in series by segments 32 of an internal register bus 30. Each segment of the internal register bus 30 connects one module 20 to a preceding module 20, a succeeding module 20, and/or the bus converter 10 to form a module pipeline. Each module 20 also connects to a data bus 40 to receive data to be processed and to output processed data. Two data buses 40 are shown in the exemplary embodiment. Those skilled in the art will appreciate, however, that the number of data buses is not material to the invention.

Bus converter 10 provides an external interface to the internal register bus 30 to enable external applications to access the registers within the modules 20. The bus converter 10 receives register requests from external applications over an interface bus (not shown) and converts register requests from an external interface protocol used on the interface bus to an internal register bus protocol used on the internal register bus 30. The bus converter 10 forwards the converted register request to the first module 20A in the module pipeline. As will be described in greater detail below, the register request is sequentially passed from one module 20 to the succeeding module 20 until it arrives at the module 20 containing the targeted register. Upon receiving the register request, the receiving module 20 decodes the target register address and compares the decoded address to its assigned register address range to determine whether the target register belongs to the receiving module 20. If the target register address falls within the register address range of the receiving module 20, the module 20 latches the register data into or reads the register data from the matching register, i.e., the register having a register address matching the target register address. If the target register address falls outside the register address range of the receiving module 20, the receiving module 20 passes the register request to the succeeding module 20.

FIG. 2 illustrates the main functional components of an exemplary module 20. Module 20 comprises a register group 22, a controller 26, and a data processing unit 28. Register group 22 comprises a decoder 23 and one or more registers 24. Registers 24 store configuration information, status information, or other information used by the module 20. The decoder 23 decodes the target register addresses associated with register requests received by the module 20 as hereinafter described. The controller 26 controls the operation of the module 20 and provides the data processing unit 28 access to the registers 24 in the register group 22. The data processing unit 28 performs the processing functions assigned to the module 20. Data processing unit 28 may perform different functions or operate in different modes depending on the configuration data stored in the registers 24. That is, by writing configuration data into the registers 24, the function or mode of the data processing unit 28 can be controlled.

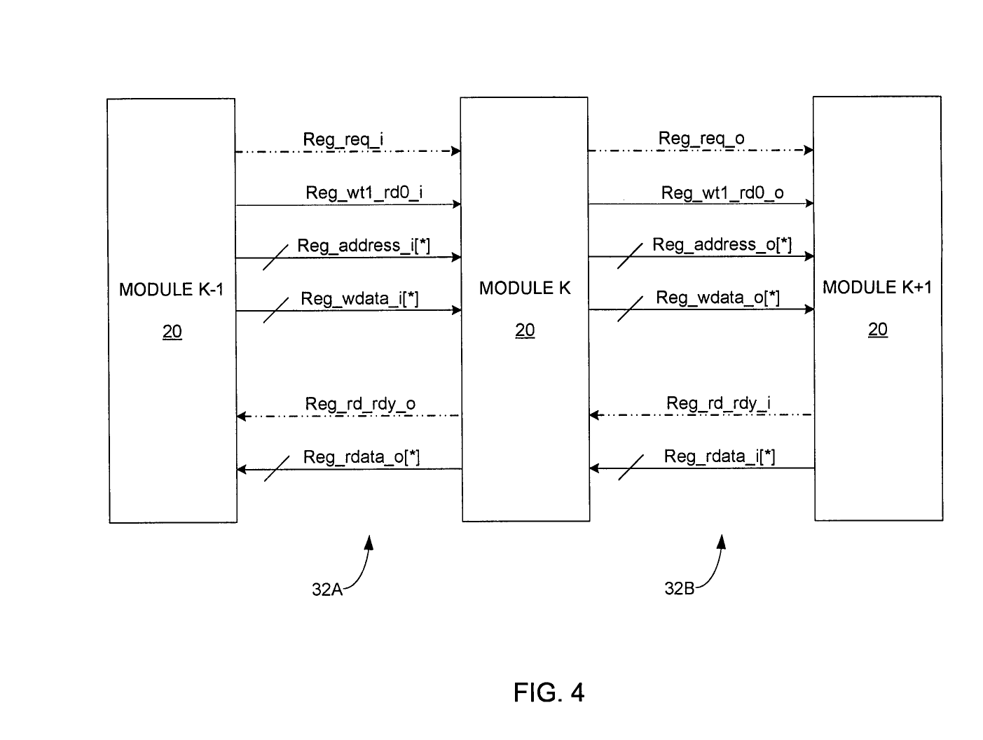

Each register 24 within the register group 22 has a corresponding register address within a predetermined register address range for the host module 20. It will be appreciated that the register address range of a module 20 comprises one or more addresses assigned to the registers 24 within the module 20, and that the register address range may be contiguous or discontiguous. The register group 22 has a first interface 21A connected by one internal bus segment 32 to a preceding module 20 or bus converter 10, and second interface 21B connected by another internal bus segment 32 to a succeeding module 20. The second interface 21B is not used by the last module 20 in the module pipeline, e.g., module 20G. The first and second interfaces are shown in FIG. 4 and described in more detail below.

To access a register 24, an external application sends a register request to the bus converter 10. The bus converter 10 converts the register request into the internal register bus protocol and forwards the converted register request to the first module 20A. The register request includes a target register address that specifies a targeted register. The register request may comprise a write request or a read request. When a register request is received by a module 20 over the first interface 21A, the decoder 23 decodes the target register address associated with the register request and compares the target register address with the address range and/or the individual addresses of its registers 24 to determine whether the targeted register belongs to the module 20. If the targeted register does not belong to the module 21 decoder 23 outputs the register request over the second interface to the succeeding module 20 in the pipeline. If the targeted register belongs to the module 20, decoder 23 either latches the write data into the targeted register (write request), or reads the register data from the targeted register (read request).

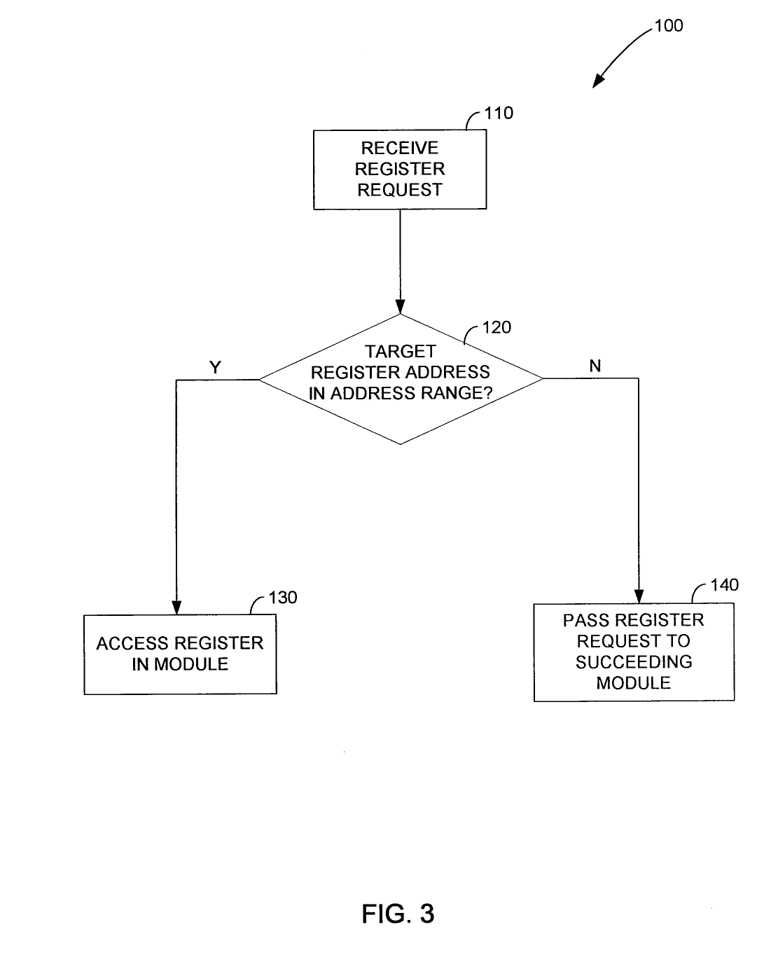

FIG. 3 shows an exemplary process 100 implemented by a processing module 20. Processing module 20 receives a register request including a target register address on a first interface (block 110) connected to a preceding module 20 or the bus converter 10 by a first segment of an internal register bus, and compares the target register address to a register address range for the receiving module 20 (block 120). If the target register address falls within the register address range of the processing module 20, the decoder 23 accesses the matching register 24 to write data into or read data from the matching register (block 130). If the target register address falls outside the register address range, the decoder 23 outputs the register request to the succeeding module 20 connected to the processing module 20 over the second interface (block 140).

FIG. 4 illustrates exemplary interfaces contained in the internal bus segments connecting Module K to a preceding module, Module K−1, and a succeeding module, Module K+1. Table 1 identifies the various lines of the internal register bus segments 32, where the symbol “?” represents either “i” or “o”, and where “i” indicates an input signal for module K and “o” indicates an output signal for module K.

TABLE 1
Internal Register Bus Interface

| Label | Definition |
|---|---|
| Reg_req_? | Register request |
| Reg_wt1_rd0_? | Write or read flag |
| Reg_address_?[*] | Request address bus indicating the target register |
| | address |
| Reg_wdata_?[*] | Write data line carrying write data when the |
| | Reg_wt1_rd0_? indicates a write flag |
| Reg_rd_rdy_? | Read out data from the target register when |
| | Reg_wt1_rd0_? indicates a read flag |
| Reg_rdata_?[*} | Valid flag of read-out data from the target register |
| | when Reg_wt1_rd0_? indicates a read flag |

The internal register bus interface comprises six interfaces. The first four interfaces listed in Table 1 provide the register request described herein to the receiving module 20, e.g., the write/read interface identifies whether the register request is a read request or a write request and the Reg_address interface carries the target register address. The remaining interfaces facilitate the read data passed up the pipeline as disclosed herein.

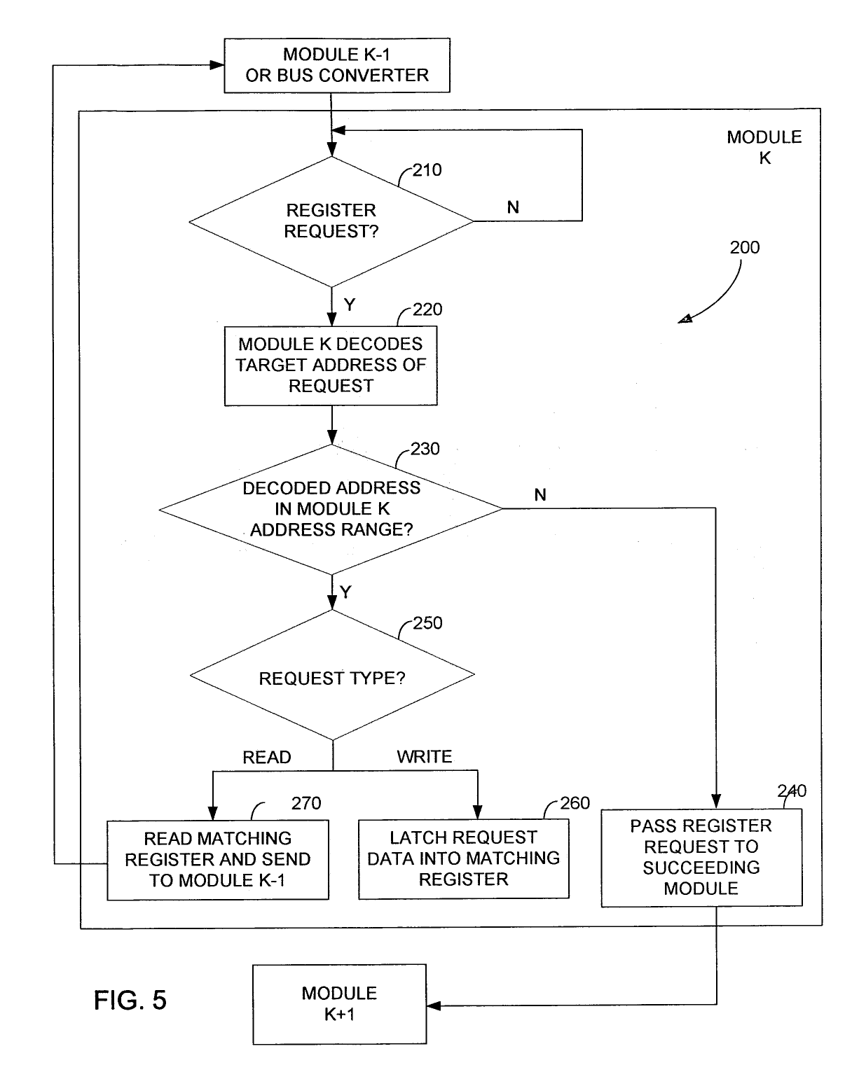

FIG. 5 discloses another exemplary method 200 executed by a module 20, Module K. Module K monitors an interface with a preceding module 20, Module K−1, or the bus converter 10 to determine when a register request is received (block 210), where the register request is sequentially passed through the modules 20. When Module K receives a register request, a decoder 23 in Module K decodes the target address of the request (block 220). If the decoded address is not in the address range of Module K (block 230), Module K passes the register request along with any associated data to the succeeding module 20, Module K+1 to pass the register request and the associated data down the module pipeline (block 240). If, however, the decoded address is in the address range of Module K (block 230), decoder 23 determines the request type (block 250). If the register request is a write request, decoder 23 latches data associated with the register request into the matching register, i.e., the register in Module K having a register address matching the target register address (block 260). If the register request is a read request, decoder 23 reads data from the matching register and sends the read data to the preceding module 20, Module K−1 to pass the read data up the module pipeline (block 270). In this case, each module 20 receives the read data from a succeeding module 20 and outputs the received read data to a preceding module 20 to pass the read data up the module pipeline.

The processing circuit 5, module 20, and corresponding methods 100 and 200 disclosed herein have several benefits over conventional implementations, e.g., better timing performance, flexible update, and reduced power consumption. In particular, because each module 20 only decodes its own register address and the internal register bus is segmented, the timing issues of the conventional solutions are avoided. Further, a new module 20 may be added by connecting it into any stage of the register pipeline without requiring any modifications to the logic functions already implemented by the processing circuit. Similarly, an old module 20 may be removed from the processing circuit by disconnecting it from the register pipeline. Also, because most of the circuit power is consumed when the internal registers are toggled, and because using the pipeline structure disclosed herein reduces the register toggle rate because the pipeline structure terminates the register request when it arrives at the module 20 containing the target register, the pipeline structure disclosed herein reduces the circuit power consumption.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-20. (canceled)

21. A method, implemented by a processing module connected with a plurality of like modules in a module pipeline, the method comprising:
receiving a register request over a first interface connected to a preceding module by a first segment of an internal register bus, the register request including a target register address;
comparing the target register address to an address range of the processing module;
in response to the target register address falling within the address range of the processing module, accessing a matching register in the processing module to write data to or read data from the matching register;
in response to the target register address falling outside the register address range, outputting the register request to a succeeding module over a second interface, the succeeding module connected to the processing module by a second segment of the internal register bus.

22. The method of claim 21:
wherein the register request comprises a write request and includes write data;
wherein accessing the matching register comprises latching the write data into the matching register.

23. The method of claim 22, further comprising outputting the write data to the succeeding module over the second interface to pass the write data down the module pipeline in response to the target register address falling outside the register address range of the processing module.

24. The method of claim 21:
wherein the register request comprises a read request;
wherein accessing the matching register comprises outputting read data from the matching register to the preceding module over the first interface.

25. The method of claim 24, further comprising:
receiving read data from the succeeding module over the second interface;
outputting the read data to the preceding module over the first interface to pass the read data up the module pipeline.

26. A processing module in processing circuit connected to a plurality of like modules forming a module pipeline, the processing module comprising:
a first interface configured to connect to a preceding module by a first segment of an internal register bus;
a second interface configured to connect to a succeeding module by a second segment of the internal register bus;
one or more registers for storing data, each register having an associated register address within a corresponding address range for the processing module;
a decoder configured to:
receive a register request over the first interface, the register request including a target register address;
compare the target register address to the address range for the processing module;
in response to the target register address falling within the register address range, access a matching register in the processing module to write data into or read data from the matching register;
in response to the target register address falling outside the address range of the processing module, outputting the register request to the succeeding module over the second interface.

27. The processing module of claim 26:
wherein the register request comprises a write request and includes write data;
wherein the decoder is configured to latch the write data into the matching register.

28. The processing module of claim 27, wherein the decoder is further configured to output the write data to the succeeding module over the second interface to pass the write data down the module pipeline in response to the target register address falling outside the register address range of the module.

29. The processing module of claim 26:
wherein the register request comprises a read request;
wherein the decoder is configured to output read data from the matching register to the preceding module over the first interface.

30. The processing module of claim 29, wherein the decoder is further configured to:
receive read data from the succeeding module over the second interface;
output the read data to the preceding module over the first interface to pass the read data up the module pipeline.

31. A method, implemented by a processing circuit having a plurality of modules connected to form a module pipeline, the method comprising:
sequentially passing a register request through the plurality of modules serially connected by an internal register bus, the internal register bus comprising a plurality of segments connecting adjacent modules, the register request including a target register address;
comparing, at each module receiving the register request, the target register address to an address range of the receiving module;
in response to the target register address falling within the address range of the receiving module, accessing a matching register within the receiving module to write data into or read data from the matching register;
in response to the target register address falling outside the address range of the receiving module and there being a succeeding module, passing the register request to the succeeding module over the internal register bus.

32. The method of claim 31:
wherein the register request comprises a write request and includes write data;
further comprising passing the write data from the receiving module down the module pipeline until the write data reaches the module containing the matching register.

33. The method of claim 32, wherein accessing the matching register comprises latching the write data into the matching register.

34. The method of claim 31:
wherein the register request comprises a read request;
wherein accessing the matching register comprises outputting read data from the matching register.

35. The method of claim 34, further comprising passing the read data up the module pipeline from the succeeding module to a preceding module.

36. A processing circuit comprising:
a plurality of modules, each including one or more registers;
an internal register bus having two or more segments connecting the plurality of modules in series to form a module pipeline and configured to pass a register request including a target register address through the serially connected modules;
a decoder for each module configured to:
compare the target register address to a register address range for the corresponding module;
in response to the target register address falling within the register address range of the corresponding module, access a matching register within the module to write data into or read data from the matching register;
in response to the target register address falling outside the register address range of the corresponding module and there being a succeeding module, pass the register request to the succeeding module.

37. The processing circuit of claim 36:
wherein the register request comprises a write request and includes write data;
wherein the decoders are configured to pass the write data from the corresponding module down the module pipeline until the write data reaches the module containing the matching register.

38. The processing circuit of claim 37, wherein the decoders are configured to latch the write data into the matching register.

39. The processing circuit of claim 36:
wherein the register request comprises a read request;
wherein the decoders are further configured to output read data from the matching register.

40. The processing circuit of claim 39, wherein the decoders are further configured to pass read data up the module pipeline to a relatively preceding module.
